(19) United States
(12) Patent Application Publication
(10) Pub. No.: US 2010/0027574 A1
(43) Pub. Date: Feb. 4, 2010

(54) OPTICAL INFORMATION RECORDING DEVICE, OPTICAL PICKUP, AND METHOD FOR EMITTING LASER LIGHT

(75) Inventors: Goro Fujita, Kanagawa (JP); Takashi Iwamura, Kanagawa (JP); Kimihiro Saito, Saitama (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/510,703

(22) Filed: Jul. 28, 2009

(30) Foreign Application Priority Data
Jul. 30, 2008 (JP) 2008-197029

(51) Int. Cl. H01S 3/00

(52) U.S. Cl. 372/38.02

(57) ABSTRACT

An optical information recording device includes a semiconductor laser for emitting laser light, a light irradiation section for collecting the laser light and irradiating an optical information recording medium with the laser light, and a laser controller for supplying the semiconductor laser with a laser drive current wave in pulse form. The laser drive current wave has an oscillation current value that causes a relaxation oscillation of the semiconductor laser.

### BACKGROUND OF THE INVENTION

1. Field of the Invention

The present invention relates to an optical information recording device, an optical pickup, and a method for emitting laser light. The invention is applicable, for example, to an optical disc device for recording information using a light beam.

2. Description of the Related Art

Among optical information recording media, optical discs have been widely used. Examples of the optical discs include compact discs (CDs), digital versatile discs (DVDs), and Blu-ray Discs (registered trademark, hereinafter referred to as BDs).

Using an optical information recording/reproducing device compatible with an optical information recording medium, various content, such as music and images, or various information, such as data for computers, can be recorded on the optical information recording medium. In recent years, an increased capacity has been demanded for the optical information recording medium, because the amount of information has increased as the definition of images and the sound quality of music have improved and an increased amount of content has been demanded to be recorded on one optical information recording medium.

In order to increase the capacity, an optical information recording medium in which information is recorded three-dimensionally in the thickness direction by using a material that allows a recording pit to be formed by two-photon absorption in accordance with light has been proposed (see, for example, Japanese Unexamined Patent Application Publication No 2005-37658).

### SUMMARY OF THE INVENTION

Because the two-photon absorption is caused only by high-intensity light, it is necessary to use a light source with high emission intensity. Examples of such light sources include a so-called short pulse output light source such as a picosecond laser and a femtosecond laser that emit laser light in short pulse form, among which a titan-sapphire laser and a YAG laser are popular.

Unfortunately, the short pulse output light source produces a short pulse output by using optical components disposed outside a light generator. This structure makes the short pulse output light source generally large and expensive, which makes it unrealistic to incorporate the short pulse output light source in an optical disc device.

Considering versatility and cost, it is desirable that a small semiconductor laser, which is widely used as a light source in an optical disc device, be used. However, in order to use the semiconductor laser as a light source, there has been a problem in that emission intensity has to be increased.

The invention provides an optical information recording device, an optical pickup, and a method for emitting laser light with which an emission intensity of a semiconductor laser can be increased.

According to an embodiment of the invention, an optical information recording device and an optical pickup include a semiconductor laser for emitting laser light, a light irradiation section for collecting the laser light and irradiating an optical information recording medium with the laser light, and a laser controller for supplying the semiconductor laser with a laser drive current wave in pulse form. The laser drive current wave has an oscillation current value that causes a relaxation oscillation of the semiconductor laser.

The embodiment of the invention can cause a relaxation oscillation of the semiconductor laser so that the semiconductor laser can output high-intensity laser light in pulse form.

According to an embodiment of the invention, a method for emitting laser light includes the steps of supplying a semiconductor laser with a laser drive current wave in pulse form, the laser drive current wave having an oscillation current value that causes a relaxation oscillation of the semiconductor laser, and emitting laser light generated by the relaxation oscillation.

The embodiment of the invention can cause a relaxation oscillation of the semiconductor laser so that the semiconductor laser can output high-intensity laser light in pulse form.

The embodiments of the invention can cause a relaxation oscillation of the semiconductor laser and cause the semiconductor laser to output high-intensity laser light in pulse form, thereby realizing an optical information recording device, an optical pickup, and a method for emitting laser light with which an emission intensity of a semiconductor laser is increased.

### BRIEF DESCRIPTION OF THE DRAWINGS

FIG. 1 is a diagram showing a structure of an optical disc;

FIG. 2 is a diagram showing an overall structure of an optical disc device;

FIG. 3 is a diagram showing a structure of an optical pickup;

FIG. 4 is a diagram showing a path of a servo light beam;

FIG. 5 is a diagram showing a path of an information light beam;

FIG. 6 is a diagram for describing a relationship between an injection carrier density and a photon density derived from equation (1);

FIG. 7 is a diagram for describing a relationship between the injection carrier density and a carrier density derived from equation (1);

FIG. 8 is a diagram for describing a relationship between the injection carrier density and a photon density derived from equation (1);

FIG. 9 is a diagram for describing the photon density at point PT1 shown in FIG. 8;

FIG. 10 is a diagram for describing the photon density at point PT2 shown in FIG. 8;

FIG. 11 is a diagram for describing the photon density at point PT3 shown in FIG. 8;

FIG. 12 is a diagram showing an actual emission waveform;

FIG. 13 is a diagram for describing a drive current and an emission intensity;

FIG. 14 is a diagram showing recording marks and emission waveforms;

FIG. 15 is a diagram showing an emission start time and an emission period;

FIGS. 16 is a diagram for describing an adjustment of supply timing of a laser drive current in a first embodiment;

FIG. 17 is a diagram for describing a drive current and an emission intensity;

FIG. 18 is a diagram for describing a current wave supply time and an emission intensity;

FIGS. 19 is a diagram for describing an adjustment of supply timing of a laser drive current in a second embodiment;

FIG. 20 is a diagram for describing a use of a pulse laser output beam LMp in another embodiment; and

FIG. 21 is a diagram for describing a use of a pulse laser output beam LMp in another embodiment.

### DESCRIPTION OF THE PREFERRED EMBODIMENTS

Hereinafter, an embodiment according to the present invention is described in detail with reference to the drawings.

### (1) First Embodiment

### (1-1) Structure of Optical Disc

First, a structure of an optical disc is described. In the present embodiment, information is recorded on an optical disc 100 by irradiating the optical disc 100 with an information light beam LM that is emitted from an optical disc device 10. On the other hand, information is read from the optical disc 100 by detecting a reflected information light beam LMr that is a reflection of the information light beam LM.

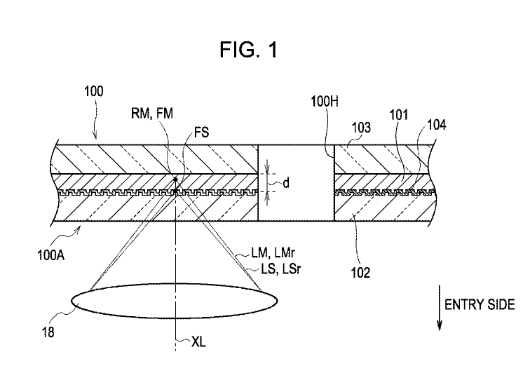

The optical disc 100 is a substantially circular plate having a chucking hole 100H at the center thereof. As shown in a sectional view of FIG. 1, the optical disc 100 includes a recording layer 101 for recording information and substrates 102 and 103 sandwiching the recording layer 101.

The optical disc device 10 collects the information light beam LM, which has been emitted by a light source, with an objective lens 18 into the recording layer 101 of the optical disc 100. When the information light beam LM has a relatively high intensity for recording, a recording mark RM is formed at a focal point FM in the recording layer 101.

The optical disc 100 further includes a servo layer 104 between the recording layer 101 and the substrate 102. The servo layer 104 has guide grooves for servo control. To be specific, a spiral track (hereinafter referred to as a servo track) STR is formed with lands and grooves as in a general BD (Blu-ray Disc, registered trademark)-R (Recordable) disc and the like.

The servo track STR has serial addresses for every predetermined number of recording bits. When information is recorded or reproduced, a servo track to be irradiated with a servo light beam LS (hereinafter referred to as a target servo track TSG) can be specified by an address.

The servo layer 104 (a boundary surface between the recording layer 101 and the substrate 102) may have pits or the like instead of the guide grooves or may have combinations of the guide grooves and the pits or the like. The shape of the servo track of the servo layer 104 may be concentric instead of being spiral.

The servo layer 104, for example, reflects a red light beam of a wavelength of about 660 [nm] with a high reflection rate, while transmitting a violet light beam of a wavelength of about 405 [nm] with a high transmission rate.

The optical disc device 10 emits a servo light beam LS of a wavelength of about 660 [nm] onto the optical disc 100. Then, the servo light beam LS is reflected by the servo layer 104 of the optical disc 100 and becomes the reflected servo light beam LSr.

The optical disc device 10 receives the reflected servo light beam LSr and, in accordance with the received light beam, controls the position of an objective lens 40 in focusing directions by moving the objective lens 40 near to and away from the optical disc 100, so that the focal point FS of the servo light beam LS is located in the servo layer 104.

At this time, the optical disc device 10 makes optical axes XL of the servo light beam LS and the information light beam LM substantially coincide with each other. Thus, the optical disc device 10 makes the focal point FM of the information light beam LM locate at a position corresponding to the target servo track TSG in the recording layer 101, i.e., at a position on a line extending through the target servo track TSG and perpendicular to the servo layer 104.

The recording layer 101 includes a two-photon absorption material that exhibits two-photon absorption at a wavelength of 405 [nm]. The two-photon absorption material exhibits two-photon absorption with an amount proportional to a square of a light intensity and only for light with a very high intensity. Examples of the two-photon absorption material include a hexadiyne compound, a cyanine dye, a merocyanine dye, an oxonol dye, a phthalocyanine dye, and an azo dye.

When the recording layer 101 is irradiated with an information light beam LM of a relatively high intensity, the two-photon absorption material is, for example, gasified by two-photon absorption so that a bubble is formed in the recording layer 101, whereby the recording mark RM is formed at the focal point FM. Alternatively, the recording mark RM may be formed in the recording layer 101 by, for example, varying a local index of refraction of the recording layer 101 with a chemical reaction.

The recording marks RM, which have been formed as described above, are disposed in a plane substantially parallel to a first surface 100A of the optical disc 100 and the servo layer 104, so that the recording marks RM form a mark layer Y.

In the recording layer 101, the recording marks RM having lengths of an integer multiple of a unit mark length (such as a length in the range of 2T to 11T) are formed.

To reproduce information from the optical disc 100, the optical disc device 10 focuses the information light beam LM to a target position PG from the first surface 100A side of the optical disk 100. If a recording mark RM has been formed at the focal point FM (i.e., target position PG), the information light beam LM is reflected by the recording mark RM as the information light beam LMr.

The optical disc device 10 generates a detection signal in accordance with a detection result of the reflected information light beam LMr, and detects whether a recording mark RM has been formed on the basis of the detection signal.

As described above, in the present embodiment, the optical disc device 10 records desired information on the optical disk 100 or reproduces desired information from the optical disc 100 by emitting the information light beam LM toward the target position PG while using the servo light beam LS at the same time.

### (1-2) Optical Disc Device

### (1-2-1) Structure of Optical Disc Device

A specific structure of the optical disc device 10 is described below.

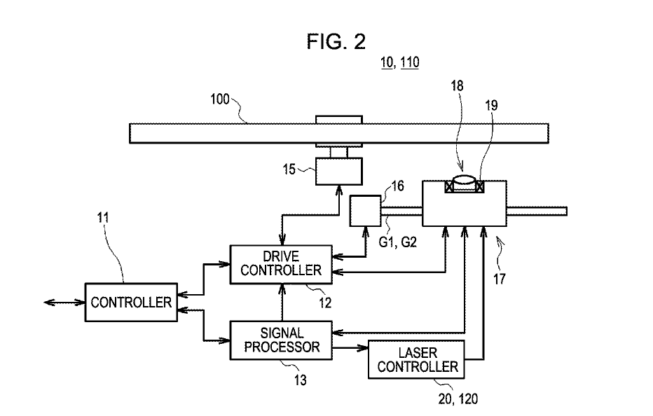

As shown in FIG. 2, the optical disc device 10 includes a controller 11 as a core component. The controller 11 includes a central processing unit (CPU, not shown), a read only memory (ROM) storing programs and the like, and a random access memory (RAM) used as a work memory by the CPU.

To record information on the optical disc 100, the controller 11 makes a drive controller 12 start a spindle motor 15 so as to rotate the optical disc 100 placed on a turntable (not shown) at a desired speed.

The controller 11 makes the drive controller 12 start a sled motor 16 so as to move an optical pickup 17 along movement shafts G1 and G2 in a tracking direction, which is a radial direction of the optical disc 100, by a large distance.

The optical pickup 17 includes a plurality of optical components such as the objective lens 18. Under control of the controller 11, the optical pickup 17 irradiates the optical disc 100 with the information light beam LM and the servo light beam LS and detects the reflected servo light beam LSr, which is a reflection of the servo light beam LS.

The optical pickup 17 generates detection signals on the basis of detection results of the reflected servo light beam LSr and supplies the detection signals to a signal processor 13. The signal processor 13 performs a specified operation on the detection signals so as to generate focus error signals SFE and tracking error signals STE and supplies the signals SFE and STE to the drive controller 12.

The focus error signal SFE is a signal that indicates the amount of deviation of the servo light beam LS from the servo layer 104 in the focusing directions. The tracking error signal STE is a signal that indicates the amount of deviation of the servo light beam LS from a servo track STR that is a target of the servo light beam LS (hereinafter referred to as a target servo track STG) in the tracking direction.

In accordance with the focus error signal SFE and the tracking error signal STE that have been supplied, the drive controller 12 generates a focus drive signal and a tracking drive signal for moving the objective lens 18, and supplies the focus drive signal and the tracking drive signal to a biaxial actuator 19 of the optical pickup 17.

In accordance with the focus drive signal and the tracking drive signal, the biaxial actuator 19 of the optical pickup 17 carries out a focus control and a tracking control of the objective lens 18 so that the focal point FS of the servo light beam LS, which has been collected by the objective lens 18, can follow a target servo track STG on a mark layer Y that is a target of the focal point FS of the servo light beam LS (hereinafter referred to as a target mark layer YG).

At this time, the controller 11 makes a laser controller 20 modulate the intensity of the information light beam LM in accordance with information supplied from outside so that the recording mark RM is formed on the target track TG of the target mark layer YG, thereby recording the information on the target track.

To reproduce information from the optical disc 100, the optical pickup 17, as in the case of recording, makes the focal point FS of the servo light beam LS follow the target servo track STG, irradiates the target track TG of the target mark layer YG with an information light beam LM having a relatively weak and substantially constant intensity, and detects the reflected information light beam LMr, which is a reflection of the information light beam LM reflected at a position at which the recording mark RM has been formed.

The optical pickup 17 generates a detection signal in accordance with the detection result of the reflected information light beam LMr, and supplies the detection signal to the signal processor 13. The signal processor 13 performs a specified operation, demodulation, and decoding on the detection signal, so that information recorded on the target track TG of the target mark layer YG can be reproduced.

### (1-2-2) Structure of Optical Pickup

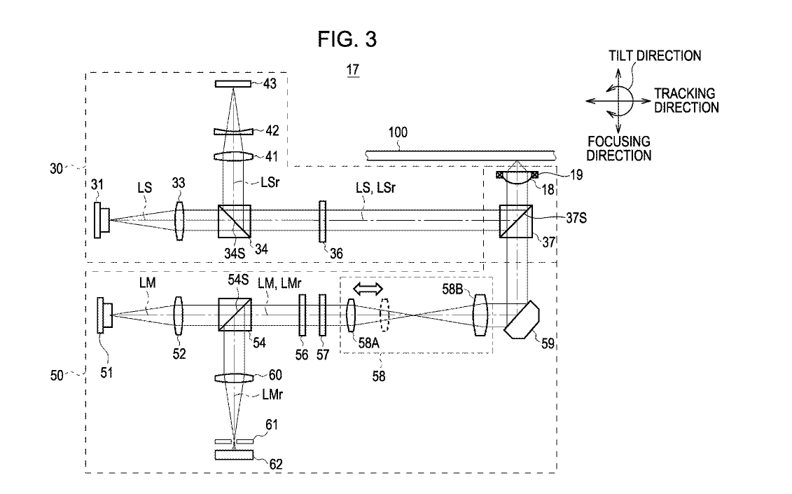

A structure of the optical pickup 17 is described below. As shown in FIG. 3, the optical pickup 17 includes a servo optical system 30 for exercising servo control and an information optical system 50 for reproducing and recording information.

In the optical pickup 17, a servo light beam LS emitted by a laser diode 31 and an information light beam LM emitted by a semiconductor laser 51 enter the same objective lens 18 respectively through the servo optical system 30 and the information optical system 50, so that the optical disc 100 can be irradiated with the servo light beam LS and the information light beam LM.

### (1-2-2-1) Optical Path of Servo Light Beam

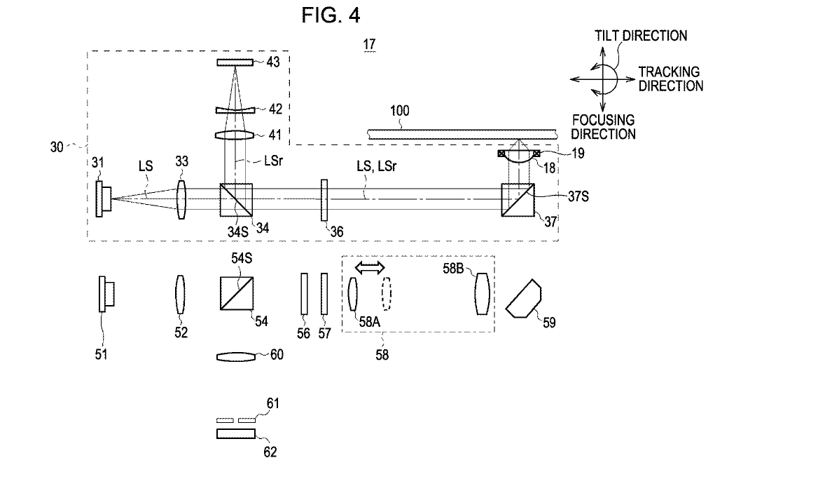

As shown in FIG. 4, in the servo optical system 30, the optical disc 100 is irradiated with the servo light beam LS through the objective lens 18, and the reflected servo light beam LSr that has been reflected by the optical disc 100 is received by a photodetector 43.

A specified amount of servo light beam LS composed of divergent light is emitted by the laser diode 31 under the control of the controller 11 (FIG. 2), and enters a collimator lens 33. The servo light beam LS is converted from divergent light to parallel light by the collimator lens 33, and enters a polarization beam splitter 34.

Almost all the servo light beam LS composed of p-polarized light passes through the polarization beam splitter 34 in the polarization direction thereof, and enters a quarter-wave plate 36.

The servo light beam LS composed of p-polarized light is converted to circularly polarized light by the quarter-wave plate 36, and enters a dichroic prism 37. The servo light beam LS is reflected by a reflection-transmission surface 37S of the dichroic prism 37 in accordance with its wavelength, and enters the objective lens 18.

The servo light beam LS is collected by the objective lens 18, and the servo layer 104 of the optical disc 100 is irradiated with the servo light beam LS. As shown in FIG. 1, the servo light beam LS passes through the substrate 102, is reflected by the servo layer 104, and becomes the reflected servo light beam LSr travelling in the opposite direction of the servo light beam LS.

The reflected servo light beam LSr is converted to parallel light by the objective lens 18, and enters the dichroic prism 37. The reflected servo light beam LSr is reflected by the dichroic prism 37 in accordance with its wavelength, and enters the quarter-wave plate 36.

The reflected servo light beam LSr composed of circularly polarized light is converted to s-polarized light by the quarter-wave plate 36, and enters the polarization beam splitter 34. The reflected servo light beam LSr composed of s-polarized light is reflected by the polarization beam splitter 34, and enters a collective lens 41.

The reflected servo light beam LSr is converged by the collective lens 41 and provided with astigmatism by a cylindrical lens 42. Then, the photodetector 43 is irradiated with the reflected servo light beam LSr.

In the optical disc device 10, wobbling or the like of the optical disc 100 may occur while the optical disk is rotating, and the position of the target servo track TSG relative to the objective lens 18 may fluctuate.

In order to make focal point FS (FIG. 1) of the servo light beam LS follow the target servo track TSG, the focal point FS has to be moved in the focusing directions, which are directions in which the objective lens 18 is made near to and away from the optical disc 100, and in the tracking direction, which is the radial direction of the optical disc 100.

For this purpose, the objective lens 18 is configured to be movable in the focusing directions and in the tracking direction with the biaxial actuator 19.

In the servo optical system 30, optical positions of optical components are adjusted such that an in-focus state in which the servo layer 104 of the optical disc 100 is irradiated with the servo light beam LS collected by the objective lens 18 is factored in an in-focus state in which the photodetector 43 is irradiated with the reflected servo light beam LSr collected by the collective lens 41.

The photodetector 43 generates a detection signal in accordance with the amount of the reflected servo light beam LSr and sends the detection signal to the signal processor 13 (FIG. 2).

The photodetector 43 has a plurality of detection areas (not shown) for receiving the reflected servo light beam LSr. The photodetector 43 detects portions of the reflected servo light beam LSr with the detection areas, generates the direction signal in accordance with the amount of detected light, and sends the detection signal to the signal processor 13 (FIG. 2).

The signal processor 13 exercises a focus control by a so-called astigmatic method. The signal processor 13 calculates a focus error signal SFE that represents the amount of deviation of the focal point FS of the servo light beam LS from the servo layer 104 of the optical disc 100, and supplies the focus error signal SFE to the drive controller 12.

Moreover, the signal processor 13 calculates a tracking error signal STE that represents the amount of deviation of the focal point FS from the target servo track TSG in the servo layer 104 of the optical disc 100, and supplies the tracking error signal STE and the focus error signal SFE to the drive controller 12.

In order to focus the servo light beam LS on a point in the servo layer 104 of the optical disc 100, the drive controller 12 exercises a feedback control (i.e., a focus control) of the objective lens 18 by generating a focus drive signal on the basis of the focus error signal SFE and supplying the focus drive signal to the biaxial actuator 19.

The drive controller 12 generates a tracking drive signal in accordance with the tracking error signal generated by a so-called push-pull method, and supplies the tracking drive signal to the biaxial actuator 19. Thus, the drive controller 12 exercises a feedback control (i.e., tracking control) of the objective lens 18, so that the servo light beam LS focuses on the target servo track TSG of the servo layer 104 of the optical disc 100.

In this way, the servo optical system 30 makes the servo layer 104 of the optical disc 100 to be irradiated with the servo light beam LS, receives the reflected servo light beam LSr, which is a reflection of the servo light beam LS, and supplies the result of receiving to the signal processor 13. The drive controller 12 exercises the focus control and the tracking control of the objective lens 18 so as to focus the servo light beam LS on the target servo track TSG of the servo layer 104.

### (1-2-2-2) Optical Path of Information Light Beam

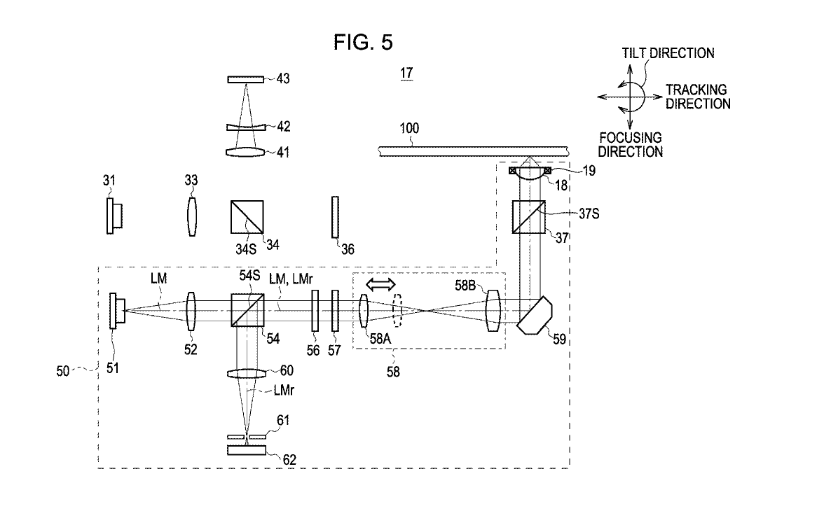

As shown in FIG. 5 corresponding to FIG. 3, with the information optical system 50, the optical disc 100 is irradiated with the information light beam LM emitted from the semiconductor laser 51 through the objective lens 18, and a photodetector 62 receives the reflected information light beam LMr reflected by the optical disk 100.

A specified amount of information light beam LM composed of divergent light is emitted from the semiconductor laser 51 under the control of the controller 11 (FIG. 2), and enters a collimator lens 52. The information light beam LM is converted from divergent light to parallel light by the collimator lens 52, and enters a polarization beam splitter 54.

The information light beam LM composed of p-polarized light passes through the polarization beam splitter 54 in the polarization direction thereof. The information light beam LM passes through a liquid crystal panel (LCP) 56, with which spherical aberration and the like are corrected, and enters a quarter-wave plate 57.

The information light beam LM is converted from p-polarized light to circularly polarized light by the quarter-wave plate 57, and enters a relay lens 58.

The information light beam LM is converted from parallel light to convergent light by a movable lens 58A of the relay lens 58. The information light beam LM, which has diverged after being converged, is reconverted to convergent light by a fixed lens 58B, and enters a mirror 59.

The information light beam LM is reflected by the mirror 59 so that the direction of travel is deflected and enters the dichroic prism 37. The information light beam LM passes through the reflection-transmission surface 37S of the dichroic prism 37 and enters the objective lens 18.

The information light beam LM is collected by the objective lens 18, and the optical disc 100 is irradiated with the information light beam LM. As shown in FIG. 1, at this time, the information light beam LM passes through the substrate 102 and focuses on a point in the recording layer 101.

The focal point FM of the information light beam LM is determined from the state of convergence when the information light beam LM exits the fixed lens 58B included in the relay lens 58. That is, the focal point FM moves in the recording layer 101 in the focusing directions in accordance with the position of the movable lens 58A.

In the information optical system 50, the position of the movable lens 58A is controlled by the controller 11 (FIG. 2) so that a depth d (i.e., distance from the servo layer 104) of the focal point FM (FIG. 1) of the information light beam LM in the recording layer 101 of the optical disc 100 can be adjusted to the target position PG.

In the information optical system 50, the objective lens 18, through which the information light beam LM passes, is servo-controlled by the servo optical system 30 so that the target position PG is in the tracking direction of the focal point FM of the information light beam LM.

The information light beam LM is collected to the focal point FM by the objective lens 18 and forms the recording mark RM at the target position PG.

To reproduce information recorded on the optical disc 100, if the recording mark RM has been recorded at the target position PG, the information light beam LM that has been collected to the focal point FM is reflected by the recording mark RM and becomes the reflected information light beam LMr, and the reflected information light beam LMr enters the objective lens 18.

On the other hand, if the recording mark RM has not been recorded at the target position PG, the information light beam LM passes through the optical disc 100 without generating the reflected information light beam LMr.

The reflected information light beam LMr is partially converged by the objective lens 18, passes through the dichroic prism 37 and the mirror 59, and enters the relay lens 58.

The reflected information light beam LMr is converted to parallel light by the relay lens 58, and enters the quarter-wave plate 57. The reflected information light beam LMr composed of circularly polarized light is converted to s-polarized light by the quarter-wave plate 57, passes through the LCP 56, and enters the polarization beam splitter 54.

The reflected information light beam LMr composed of s-polarized light is reflected the polarization surface 54S of the polarization beam splitter 54, and enters a multilens 60. The reflected information light beam LM is collected by the multilens 60, passes through a pinhole plate 61, and directed toward the photodetector 62.

The pinhole plate 61 is disposed such that the focal point of the reflected information light beam LMr collected by the multilens 60 is positioned in a hole (no numeral) thereof, and allows the reflected information light beam LMr to pass therethrough.

This structure enables the photodetector 62 to generate a detection signal SDb in accordance with the amount of the reflected information light beam LMr without being affected by stray light, and supplies the signal to the signal processor 13 (FIG. 2).

The signal processor 13 applies specific demodulation, decoding, or the like to the reproduction detection signal SDb so as to generate reproduced information, and supplies the reproduced information to the controller 11.

In this way, the information optical system 50 receives the reflected information light beam LMr, which is reflected from the optical disc 100 toward the objective lens 18, and supplies the result of receiving the light beam to the signal processor 13.

### (1-3) Characteristic of Laser

A so-called rate equation that expresses a characteristic of a laser is shown below. In equation (1), Γ is a confinement coefficient, τₚₕ is a photon lifetime, τₛ is a carrier lifetime, Cₛ is a spontaneous emission coupling coefficient, d is an active layer thickness, q is the elementary electric charge, gₘₐₓ is a maximum gain, N is a carrier density, S is a photon density, J is an injection carrier density, c is the velocity of light, N₀ is a transparency carrier density, and n_{g} is a group refraction index.

$$\frac{dN}{dt} = - Γ GS - \frac{N}{{τ}_{s}} + \frac{J}{dq} \\ \frac{dS}{dt} = Γ GS - \frac{S}{{τ}_{ph}} + {C}_{s} \frac{N}{{τ}_{s}} \\ where \\ G = \frac{c}{{n}_{g}} {A}_{g} ( N - {N}_{0} ) = \frac{c}{{n}_{g}} {g}_{max} \qquad ( 1 )$$

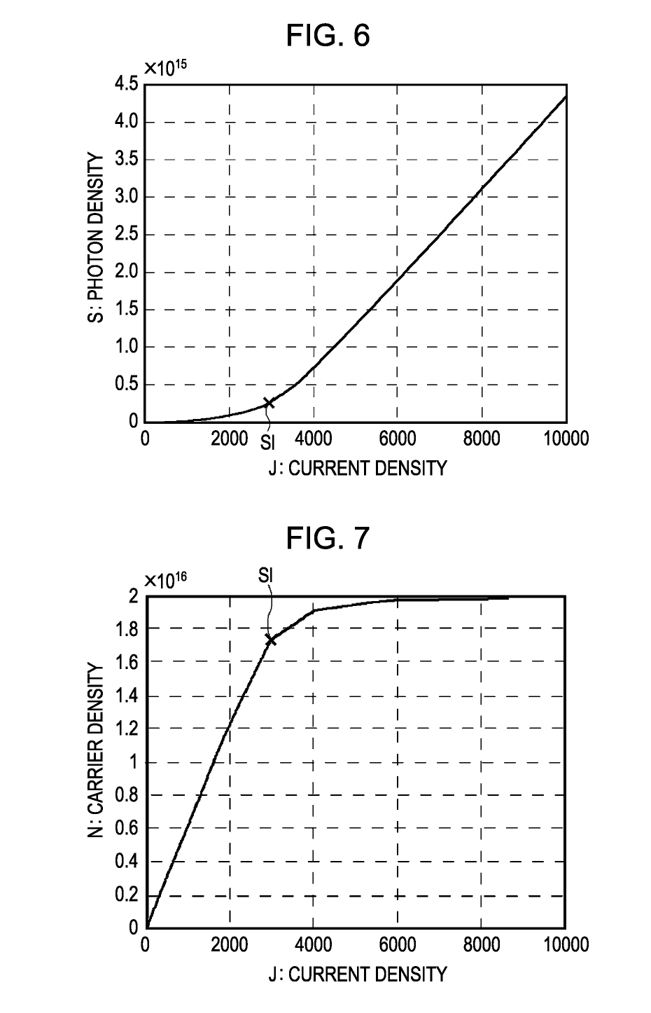

FIGS. 6 shows a relationship between the injection carrier density J and the photon density S derived from the equation (1), and FIG. 7 shows a relationship between the injection carrier density J and the carrier density N derived from the equation (1). For FIGS. 6 and 7, calculations are made by assuming that Γ=0.3, A_{g}=3e⁻¹⁶ [Cm²], τₚₕ=1e⁻¹²[s], τₛ=1e⁻⁹ [s], Cₛ=0.03, d=0.1 [μm], q=1.6e⁻¹⁹ [C].

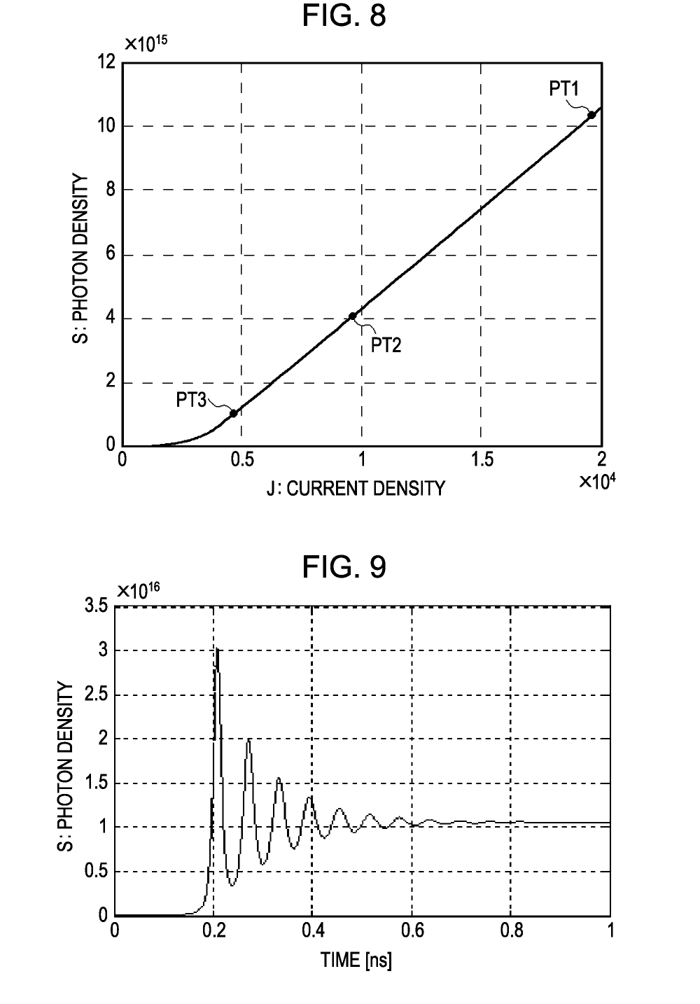

As shown in FIG. 7, as the injection carrier density J (i.e., laser drive current DJ) increases, a general semiconductor laser starts to emit light at a pre-saturation point S1 that is slightly before a point where the carrier density N saturates. As shown in FIG. 6, as the injection carrier density J increases, the semiconductor laser increases the photon density S (i.e., emission intensity). As shown in FIG. 8 corresponding to FIG. 6, as the injection carrier density J further increases, the photon density S further increases.

In FIGS. 9, 10, and 12, the horizontal axis represents the time when the laser drive current DJ having the injection carrier density J corresponding to the points PT1, PT2, and PT3 shown FIG. 8 is started to be supplied, and the vertical axis represents the photon density S.

As shown in FIG. 9, at the point PT1 where the largest laser drive current DJ is supplied, the photon density S considerably oscillates due to a relaxation oscillation with a large amplitude, and the oscillation period ta (interval between a minimal value and a subsequent minimal value) is as short as 50 [ps]. Regarding the oscillation of the photon density S, the amplitude of the first wave, which appears right after the emission starts, is the largest, and the amplitude of the second, third, and subsequent waves gradually decreases and finally become stabilized.

For the point PT1, the maximum value of the photon density S of the first wave is about 3×10¹⁶, which is about three times a plateau value (about 1×10¹⁶) when the photon density S stabilizes. For the point PT1, the emission start time τd, which is an interval between the time when the laser drive current DJ is started to be supplied and the time when emission starts, is as short as about 200 [ps].

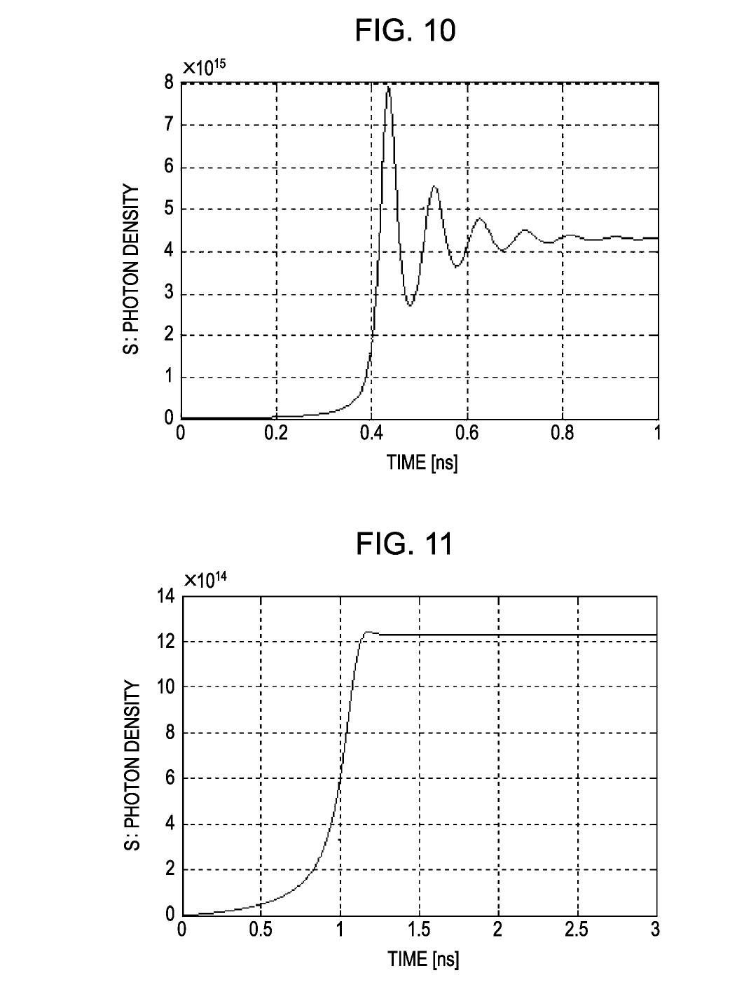

As shown in FIG. 10, at the point PT2 where the value of supplied laser drive current DJ is smaller than that of the point PT1, although a relaxation oscillation clearly occurs, the amplitude of the oscillation is smaller than that of the point PT1, and the oscillation period ta is as large as 100 [ps]. Moreover, at the point PT2, the emission start time τd is 400 [ps], which is longer than that of the point PT1. At the point PT2, the maximum value of the photon density S of the first wave is about 8×10¹⁵, which is about twice a plateau value (about 4×10¹⁵).

As shown in FIG. 11, at the point PT3, where the value of the supplied laser drive current DJ is smaller than that of the point PT2, a relaxation oscillation occurs only negligibly, and the emission start time τd is 1 [ns], which is comparatively long. The maximum value of the photon density S at the point PT3 is about 1.2×10¹⁵, which is approximately the same as the plateau value.

In a general optical disc device, a comparatively small laser drive current under the condition (current value) that a relaxation oscillation negligibly occurs as seen in the point PT3 is supplied to a semiconductor laser so as to decrease a difference in emission intensity immediately after light emission is started and stabilize the output of the laser light.

In contrast, the optical disc device 10 of the present embodiment is configured such that a relaxation oscillation occurs as in the points PT1 and PT2, so that the maximum value of the instantaneous intensity of the laser light becomes larger than the plateau value (for example, equal to or greater than 1.5 times the plateau value). Moreover, because a large current value (hereinafter referred to as an oscillation current value α) can be used for generating the relaxation oscillation, laser light with a large intensity corresponding to the large oscillation current value α can be emitted.

That is, by supplying the same semiconductor laser with a laser drive current DJ having the oscillation current value α, the intensity of the laser light can be substantially increased as compared with that of general optical disc devices. For example, at the point PT1, the photon density S for the first wave of the relaxation oscillation is about 3×10¹⁶, which implies that the intensity of laser light emitted by the semiconductor laser 51 can be increased by 20 times as compared with the case of the point PT3 (about 1.2×10¹⁵) at which current value for general optical devices is supplied.

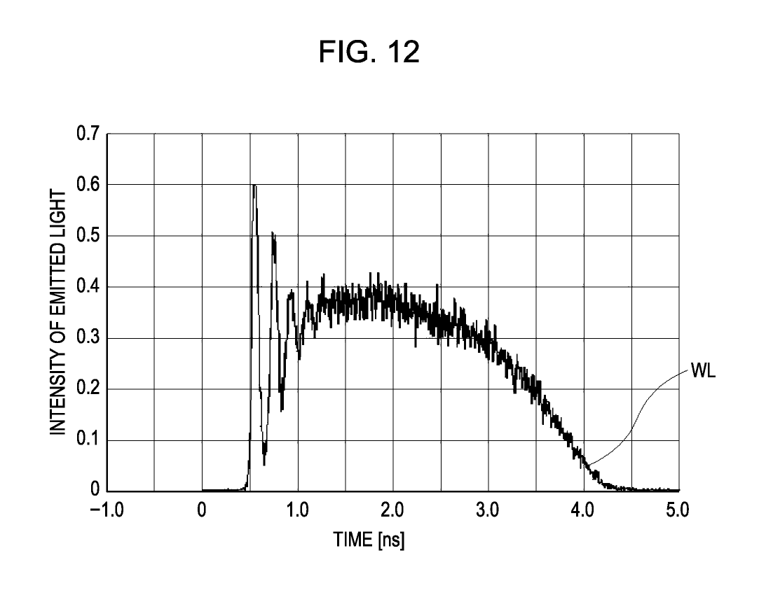

FIG. 12 shows an actual measurement of emission intensity when a comparatively large amount of laser drive current DJ is supplied to the semiconductor laser 51 (SLD3233VF made by SONY Corporation). As shown in FIG. 12, a relaxation oscillation of the photon density S shown in FIGS. 9 and 10 occurs at the emission intensity, which indicates that a similar relaxation oscillation occurs at the emission intensity. An emission waveform WL shown in FIG. 12 is obtained when the laser drive current DJ in a rectangular pulse form is supplied to the semiconductor laser 51. Hereinafter, a portion of the laser drive current DJ that is supplied in pulse form is referred to as a laser drive current wave DJw.

In this way, in the optical disc device 10, the laser drive current DJ of a large oscillation current value α is supplied to the semiconductor laser 51 so as to intentionally cause a relaxation oscillation, so that the semiconductor laser can emit high-intensity laser light as the information light beam LM.

### (1-4) Emission of Information Light Beam

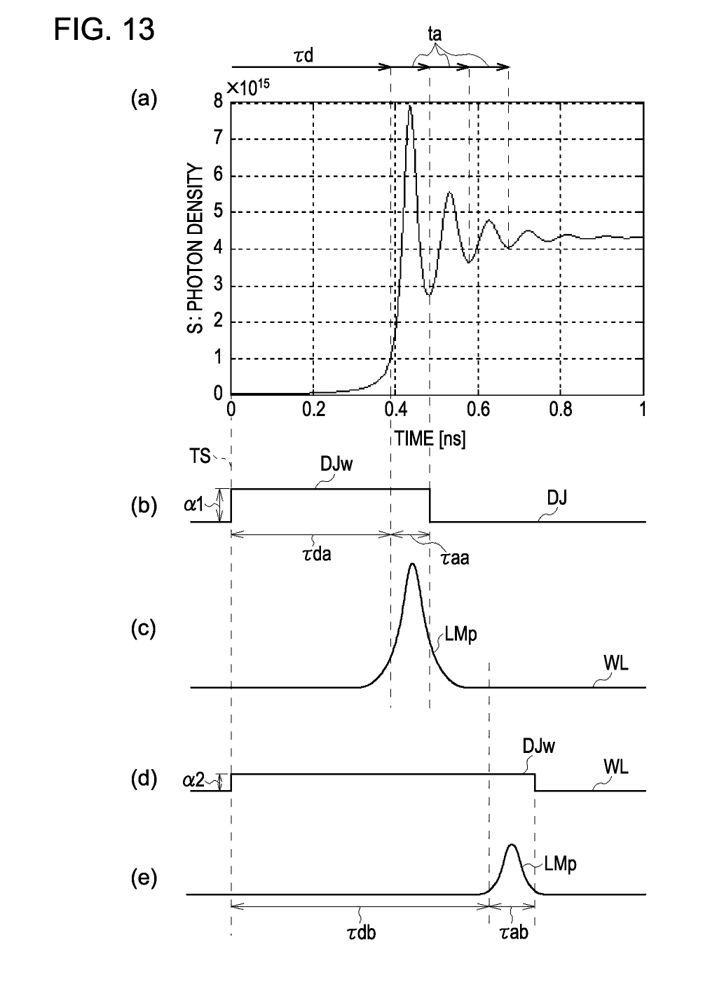

In FIG. 13, part (a) corresponds to FIG. 10. As shown in part (b) of FIG. 13, the laser controller 20 of the optical disc device 10 supplies, as a laser drive current wave DJw, a laser drive current DJ with an oscillation current value α1 that is sufficiently large to cause a relaxation oscillation of the semiconductor laser 51. At this time, the laser controller 20 supplies the laser drive current wave DJw, which is the laser drive current DJ composed of a rectangular pulse wave, for a time (hereinafter referred to as a current wave supply time β) in which an emission start time τd and an oscillation period ta are added (τd+ta).

Thus, as shown in part (c) of FIG. 13, the laser controller 20 causes the semiconductor laser 51 to emit only the first wave of the relaxation oscillation, thereby causing the semiconductor laser 51 to emit high-intensity pulsed laser light (hereinafter referred to as a pulse laser output beam LMp) as the information light beam LM.

Because the laser controller 20 supplies the laser drive current wave DJw in pulse form, the time during which the laser drive current DJ with a high current value is supplied is shortened, so that malfunction of the semiconductor laser 51 caused by overheating or the like of the semiconductor laser 51 can be reduced.

As shown in part (d) of FIG. 13, the laser controller 20 can supply a laser drive current wave DJw having an oscillation current value α2 that is sufficiently large for causing a relaxation oscillation but smaller than the oscillation current value α1 to the semiconductor laser 51 so that the semiconductor laser 51 emits a pulse laser output beam LMp with a comparatively low intensity.

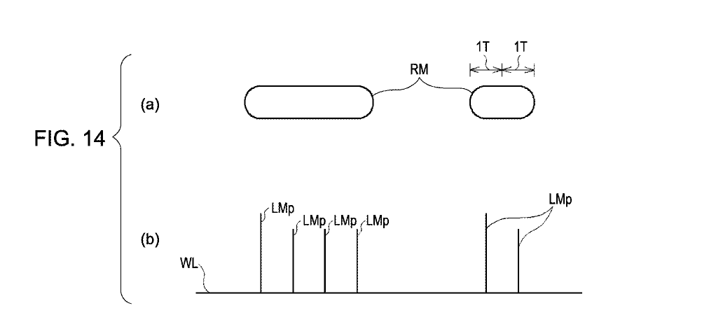

As shown in FIG. 14, when the primitive period is 1T, the optical disc device 10 forms recording marks RM having a plurality of mark lengths (for example, lengths in the range of 2T to 11T). With the optical disc device 10, a recording mark RM having a length of 1T is formed by one pulse of the pulse laser output beam LMp.

At this time, the optical disc device 10 emits the pulse laser output beam LMp with a relatively high intensity (first intensity) at a leading edge portion of the recording mark RM, and with a relatively low intensity (second intensity) in the remaining portion.

Thus, the optical disc device 10 prevents an overlapping irradiation of the pulse laser output beam LMp, which may make an absorption reaction in the remaining portion of the recording mark RM stronger than that of the leading edge portion, thereby providing the recording mark RM with a substantially uniform shape (widths in the focusing directions and in the tracking direction).

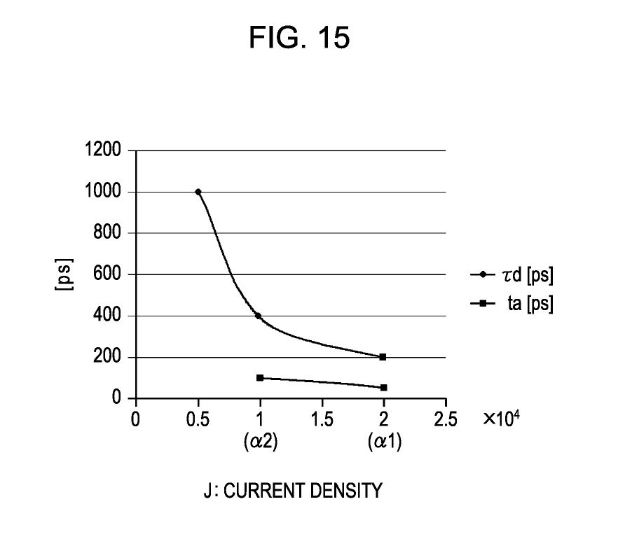

As shown in FIG. 15, the emission start time τd varies in accordance with the oscillation current value α of the laser drive current DJ. The emission start time τd, which is an interval between the current wave supply start time TS when a current is started to be supplied and the time when the light is started to be emitted, is longer for the case when the semiconductor laser 51 is supplied with the laser drive current wave DJw with a comparatively small oscillation current value α2 (parts (d) and (e) of FIG. 13) than for the case when the semiconductor laser 51 is supplied with the laser drive current wave DJw with a comparatively small oscillation current value α1 (parts (b) and (c) of FIGS. 13).

Therefore, as shown in parts (b) and (d) of FIG. 13, if the laser controller 20 supplies the semiconductor laser 51 with the laser drive current waves DJw having different oscillation current values α at the same timing, the pulse laser output beams LMp are emitted at different timings, which makes a distance between the recording marks RM deviate from a multiple of the reference period 1T.

Therefore, the laser controller 20 is configured such that the supply timing of the laser drive current wave DJw is adjustable in accordance with the oscillation current value α.

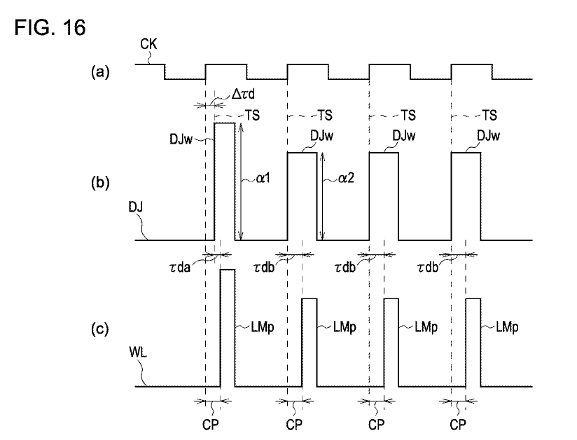

Referring to FIG. 16, a case when the pulse laser output beam LMp is output with a first intensity corresponding to a first oscillation current value α1 and a case when the pulse laser output beam LMp is output with a second intensity corresponding to a second oscillation current value α2 are described. For convenience of illustration, an emission waveform WL of the pulse laser output beam LMp is shown in rectangular shapes.

The laser controller 20 of the optical disc device 10 starts to supply the laser drive current wave DJw having the second oscillation current value α2 in response to a rising edge of the reference clock CK. That is, the laser controller 20 outputs the pulse laser output beam LMp with reference to the second oscillation current value α2. At this time, the semiconductor laser 51 outputs the pulse laser output beam LMp with a delay of a predetermined emission start time τdb after the current wave supply start time TS.

The laser controller 20 starts to supply the laser drive current DJ having the first oscillation current value α1 at a timing delayed by a delay time Δτd after the rising edge of the reference clock CK. The delay time Δτd is the difference between the emission start time τdb for the second oscillation current value α2 and the emission start time τda for the first oscillation current value α.

That is, as shown in FIG. 15, if, for example, the injection carrier density J corresponding to the first oscillation current value α1 is 2×10⁴, and the injection carrier density J corresponding to the second oscillation current value α2 is 1×10⁴, the emission start times τda and τdb are 200 [ps] and 400 [ps], respectively. Therefore, the delay time Δτd is 400 [ps]−200 [ps], which is 200 [ps].

As a result, as shown in part (c) of FIG. 16, the laser controller 20 outputs the pulse laser output beam LMp at a timing delayed by the emission start time τda from the current wave supply start time TS delayed by Δτd from the reference clock CK (that is, at a timing delayed by Δτd+τda=τdb from the reference clock CK).

In other words, the laser controller 20 can make the clock delay time CP, which is the interval between the reference clock CK to the time when the pulse laser output beam LMp is output for the first oscillation current value α1 and the second oscillation current value α2, to be approximately the same, thereby allowing the pulse laser output beam LM to be output at approximately the same interval.

As shown in FIG. 15, the difference between an oscillation period taa for the first oscillation current value α1 and an oscillation period tab for the second oscillation current value α2 is very small. Thus, the difference in the oscillation period ta does not considerably affect the clock delay time CP. However, the current wave supply start time TS may be adjusted in accordance with the difference between the oscillation periods taa and tab.

In accordance with a recording signal supplied from the signal processor 13, the laser controller 20 of the optical disc device 10 generates a recording pulse signal (not shown) corresponding to an emission waveform WL to be output from the semiconductor laser 51.

If the peak intensity of the recording pulse signal is a first pulse intensity corresponding to the first emission intensity, the laser controller 20 sets the oscillation current value α of the laser drive current wave DJw at the first oscillation current value α1 and delays the current wave supply start time TS for supplying the current wave having the oscillation current value α1 by Δτd from the reference clock CK.

If the peak intensity of the recording pulse signal is a second pulse intensity corresponding to the second emission intensity, the laser controller 20 sets the oscillation current value α of the laser drive current wave DJw at the second oscillation current value α2 and makes the current wave supply start time TS for supplying the current wave having the second current value α2 coincide with a rising edge of the reference clock CK.

Thus, the optical disc device 10 appropriately adjusts the oscillation current value α of the laser drive current wave DJw so that the emission intensity of the information light beam LM composed of the pulse laser output beam LMp can be adjusted to an arbitrary value. Moreover, the optical disc device 10 adjusts the current wave supply start time TS in accordance with the oscillation current value α so that the pulse laser output beams LMp can be emitted at timings delayed by the same clock delay time CP from the reference clock CK irrespective of the oscillation current value α. As a result, the optical disc device 10 can form the recording mark RM in accordance with an arbitrary period that is a multiple of 1T.

### (1-5) Operation and Advantage

As described above, in the optical disc device 10, the information light beam LM composed of laser light is emitted by the semiconductor laser 51, the information light beam LM is collected, and the optical disc 100 as an optical information recording medium is irradiated with the information light beam LM. The optical disc device 10 is configured such that the semiconductor laser 51 is supplied with the laser drive current wave DJw in pulse form having the oscillation current value α that causes a relaxation oscillation of the semiconductor laser 51.

Thus, in the optical disc device 10, the laser drive current wave DJw having an oscillation current value α that is larger than that of existing optical disc devices can be supplied to the semiconductor laser 51, so that the output of the entire semiconductor laser 51 can be increased and the pulse laser output beam LMp having a high emission intensity due to the relaxation oscillation can be emitted.

The optical disc device 10 sets a current wave supply time β at a time shorter than an initial oscillation time. The current wave supply time β is an interval between the times when the laser drive current wave DJw of the oscillation current value α is started to be supplied and stopped being supplied. The initial oscillation time is the sum of the oscillation period ta of the relaxation oscillation and the emission start time τd that is an interval between the time when the laser drive current wave DJw is started to be supplied and the time when the information light beam LM is emitted.

Thus, the optical disc device 10 uses only the first wave that provides the largest emission intensity, so that the emission intensity of the information light beam LM can be further increased.

The optical disc device 10 increases/decreases the oscillation current value α so as to increase/decrease the emission intensity of the information light beam LM. By varying the oscillation current value α, the optical disc device 10 can freely set the emission intensity of the information light beam LM.

The optical disc device 10 varies the current wave supply start time TS, which is the time at which the laser drive current wave DJw is started to be supplied, in accordance with an increase/decrease in the oscillation current value α.

Thus, the optical disc device 10 can offset the variation of the emission start time τd in accordance with the oscillation current value α with the variation of the current wave supply start time TS. As a result, the optical disc device 10 emits a pulse laser output beam LM regardless of the oscillation current value α, so that the recording mark RM can be precisely formed.

The optical disc device 10 forms the recording mark RM representing information by irradiating the recording layer 101, which is made of a homogeneous material, with the information light beam LM at a position near the focal point FM of the information light beam LM and thereby forming a pit that causes a refractive index modulation in the recording layer 101.

The optical disc 100 does not have a signal recording surface as in existing optical discs such as a DVD (Digital Versatile Disc) or a BD, which may cause the optical energy of the information light beam LM to be easily diffused three-dimensionally and may increase time for forming the recording mark RM. However, the optical disc device 10 emits the information light beam LM having a high emission intensity in a short time, so that a recording mark RM can be formed before the optical energy is considerably diffused, whereby the optical energy can be effectively used.

The optical disc device 10 forms the recording mark RM using the information light beam LM emitted in accordance with a plurality of laser drive current waves DJw and varies the oscillation current value α of the laser drive current waves DJw so that the width of the recording mark RM is substantially constant.

Thus, the optical disc device 10 makes the widths of the recording marks RM to be the same, so that interference between the recording marks RM that are adjacent to each other in the tracking direction or in the focusing directions is suppressed, whereby the signal to noise (S/N) ratio of a reproduced signal information can be improved.

The optical disc device 10 irradiates the recording layer 101 with the information light beam LM. The recording layer 101 includes a two-photon absorption material that exhibits nonlinear absorption in accordance with the amount of the information light beam LM. Thus, the optical disc device 10 can effectively cause two-photon absorption by fully utilizing a high emission intensity characteristic of the pulse laser output beam LMp.

With the structure, the optical disc device 10 can cause a relaxation oscillation of the semiconductor laser 51 with a large amplitude of emission intensity by supplying the semiconductor laser 51 with the laser drive current wave DJw having a large oscillation current value α. Therefore, the embodiment of the invention realizes an optical information recording device, an optical pickup, and a method for emitting laser light, with which the emission intensity of the semiconductor laser 51 is increased.

### (2) Second Embodiment

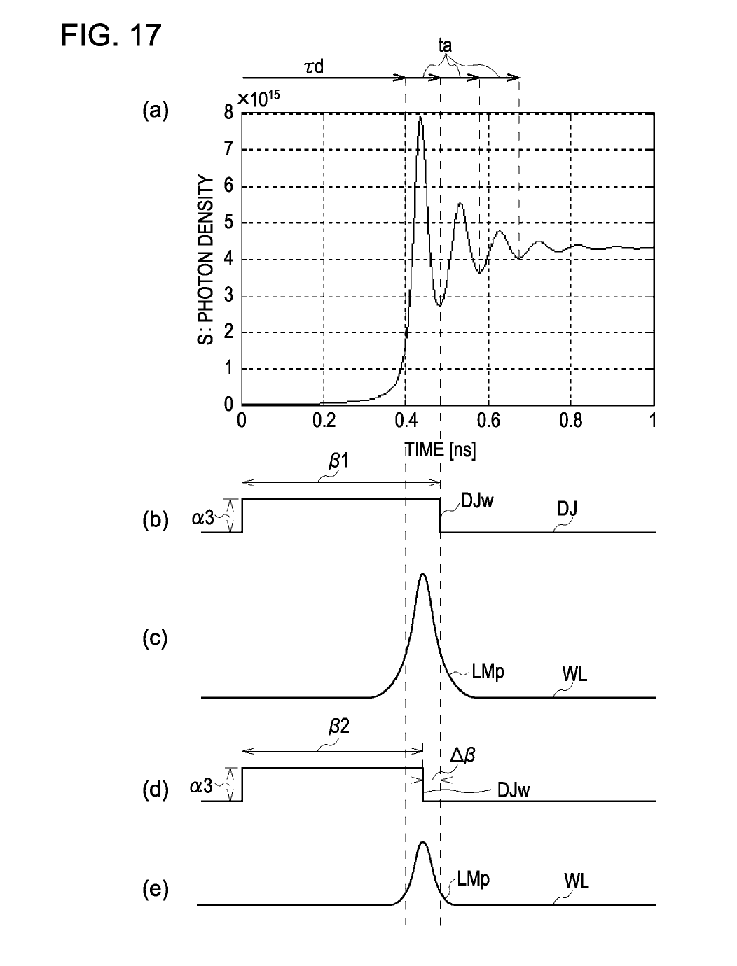

FIGS. 17 to 19 show a second embodiment. The same numerals are used for portions that correspond to the portions of a first embodiment shown in FIGS. 1 to 16. An optical disc device 110 of the second embodiment is different from the first embodiment in the method for generating the laser drive current DJ. The description of the optical disc device 110 (FIG. 2) is omitted because the structure of the optical disc device 110 is the same as that of the optical disc device 10.

### (2-1) Method for Generating Laser Drive Current

As shown in FIG. 17 corresponding to FIG. 13, even when the semiconductor laser 51 is supplied with the same oscillation current value α (α3), if the laser drive current DJ is stopped being supplied during the first wave of the relaxation oscillation (i.e., before a first oscillation period ta has passed after the emission start time τd), the emission intensity of the pulse laser output beam LMp is reduced. If the laser drive current DJ is stopped being supplied before the first wave reaches a maximal value, the emission intensity of the pulse laser output beam LMp can be effectively reduced.

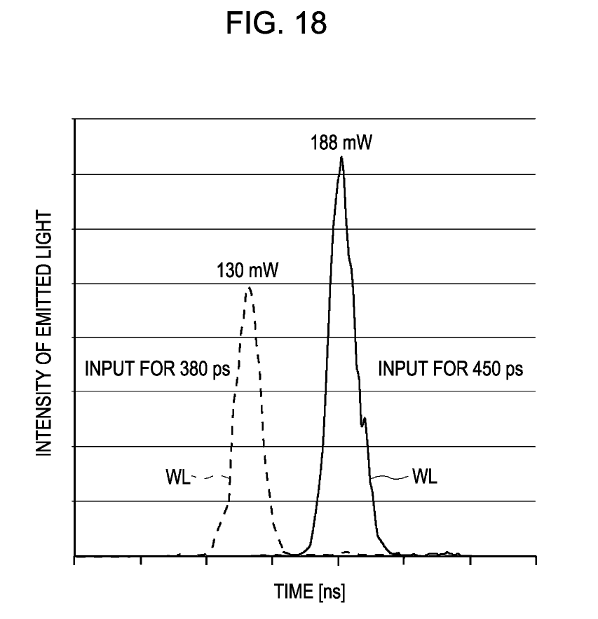

FIG. 18 shows an emission waveforms WL of the pulse laser output beam LMp when a typical semiconductor laser (SLD3233VF made by SONY Corporation) is supplied with the rectangular laser drive current wave DJw whose current wave supply time β is 380 [ps] and 450 [ps]. The horizontal coordinate T, which represents time for comparing widths of the pulse laser output beams LMp, is not an absolute time, and one scale corresponds to 0.5 [ns]. For convenience of comparison, the waveforms of the pulse laser output beams LMp are translated in the horizontal direction.

As shown in FIG. 18, when the laser drive current wave DJw is supplied for 450 [ps], the emission intensity is 188 [mW]. When the laser drive current wave DJw is supplied for 380 [ps], the emission intensity is as small as 130 [mW].

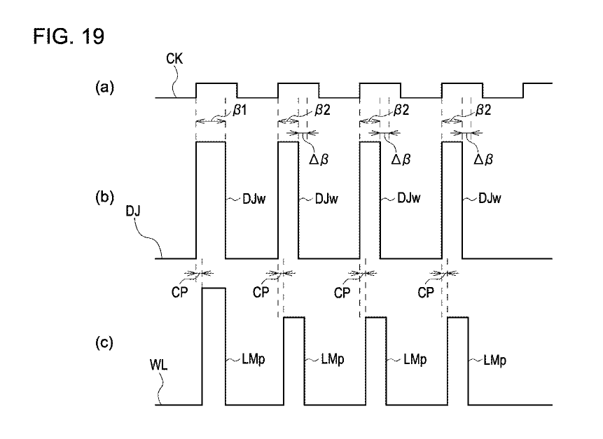

As shown in FIG. 19, a laser controller 120 (FIG. 2) of the optical disc device 110 starts to supply a laser drive current wave DJw having an oscillation current value α3 in response to a rising edge of the reference clock CK. If the laser controller 120 maintains the oscillation current value α3, for example, during a first current wave supply time β1 that equals to “an emission start time τd+an oscillation period ta”, a pulse laser output beam LMp having a first emission intensity is emitted.

On the other hand, if the laser controller 120 stops supplying the laser drive current wave DJw after a second current wave supply time β2 that is less than “the emission start time τd+the oscillation period ta”, a pulse laser output beam LMp having a second emission intensity is emitted. That is, the laser controller 120 sets the second current wave supply time β2 at a time shorter than the first current wave supply time β1 by the amount of Δβ.

As a result, as shown in part (c) of FIG. 19, the laser controller 20 can switch the emission intensity of the pulse laser output beam LMp between the first and second emission intensity while keeping the clock delay time CP, which is a time before the pulse laser output beam LMp is output, to be approximately the same for the cases when the current wave is supplied for the first current wave supply time β1 and for the second current wave supply time β2.

That is, to supply the laser drive current wave DJw corresponding to a leading edge of the recording mark RM, the laser controller 20 sets the current wave supply time β at the first current wave supply time β1. Then, in response to a rising edge of the reference clock CK, the laser controller 20 supplies the semiconductor laser 51 with the laser drive current wave DJw that maintains an oscillation current value α3 during the first current wave supply time β1.

On the other hand, to supply the laser drive current wave DJw corresponding to the remaining portion of the recording mark RM, the laser controller 20 sets the current wave supply time β at the second current wave supply time β2. Then, in response to a rising edge of the reference clock CK, the laser controller 20 supplies the semiconductor laser 51 with the laser drive current wave DJw that maintains the oscillation current value α3 for the second current wave supply time β2.

In this way, the optical disc device 10 appropriately adjusts the current wave supply time β of the laser drive current wave DJw so that the emission intensity of the pulse laser output beam LMp can be adjusted to a desired value.

### (2-2) Operation and Advantage

As described above, the optical disc device 10 increases/decreases the emission intensity of the information light beam LM by varying the current wave supply time β. Thus, the optical disc device 10 can emit a pulse laser output beam LMp at approximately the same timing with reference to the reference clock CK regardless of the emission intensity by constantly supplying the semiconductor laser 51 with the laser drive current wave DJw at timings corresponding to the reference clock CK.

With the above-described structure, the optical disc device 10 sets the current wave supply time β of the laser drive current wave DJw at a time shorter than the initial oscillation time, in which the emission start time τd and the oscillation period ta are added, so as to reduce the emission intensity of the laser drive current wave DJw without varying the oscillation current value α. As a result, the optical disc device 10 can generate the laser drive current DJ simply by varying the current wave supply time β without changing the oscillation current value α and the timings at which the laser drive current wave DJw is started to be supplied.

### (3) Other Embodiments

In the first and second embodiments, only the first wave of the relaxation oscillation is used for the information light beam LM. However, the invention is not limited thereto, and the second wave and the waves after the third wave can be used.

In the first and second embodiments, the recording layer 101 includes a two-photon absorption material that exhibits nonlinear absorption. However, the invention is not limited thereto, and, as a material that exhibits nonlinear absorption, for example, gold or silver nanoparticles that cause a plasmon resonance can be used.

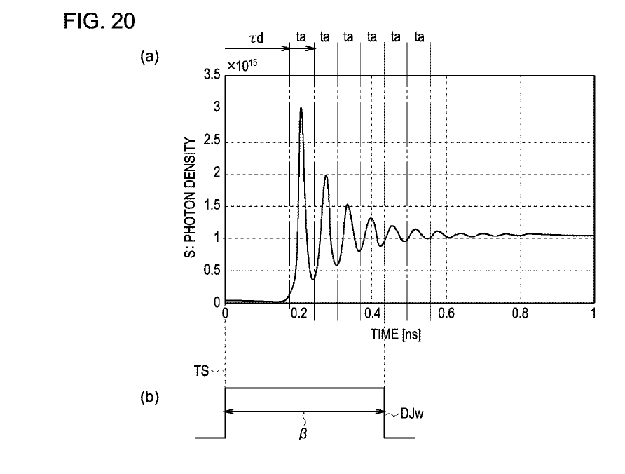

Moreover, a recording layer that allows a recording marks RM to be formed in accordance with an accumulated amount of optical energy may be irradiated with a light beam LM. In this case, as shown in FIG. 20, the laser controller 20 sets a current wave supply time β, which is the interval between the times when the laser drive current wave DJw having an oscillation current value α is started to be supplied and stopped being supplied, at an oscillation period in which an emission start time τd, which is the interval from the time when the laser drive current wave DJw is started to be supplied and the time when laser light is emitted, and a multiple of the oscillation period ta of the relaxation oscillation are added (i.e., emission start time τd+n×oscillation period ta, where n is a natural number).

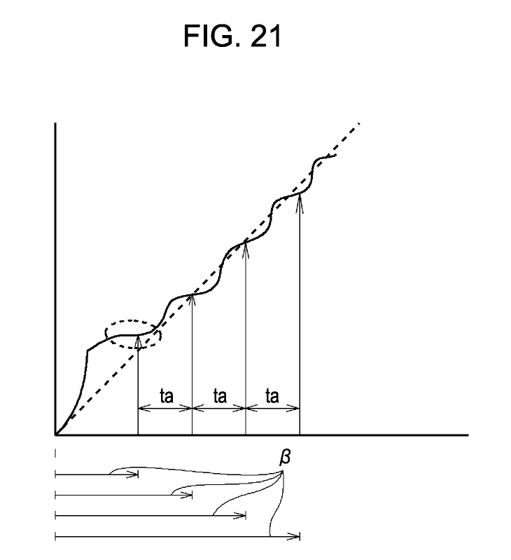

Thus, as shown in FIG. 21, the optical disc device 10 can stop supplying the laser drive current wave DJw at a time when the increase in the accumulated amount of optical energy decelerates. Thus, even if the current wave supply time β deviates, the optical disc device 10 can moderate a fluctuation of the accumulated amount of optical energy for each laser drive current wave DJw so as to reduce a load for the laser drive control. Also in this case, it is preferable that the laser drive current wave DJw be in pulse form and that the current wave supply time β be short (for example, equal to or shorter than 2000 [ps], or more preferably, equal to or shorter than 1000 [ps]) so as to suppress the load to the semiconductor laser 51.

In the first and second embodiments, rectangular pulse wave currents are supplied as the laser drive current wave DJw. However, the invention is not limited thereto. It is sufficient that pulse current having a large oscillation current value α is supplied for a short time. For example, a laser drive current wave DJw having a sinusoidal shape may be supplied.

In the first and second embodiments, a general semiconductor laser (for example, SLD3233VF made by SONY Corporation) is used as the semiconductor laser 51. However, the invention is not limited thereto. It is sufficient that a so-called semiconductor laser, which conducts laser emission by using p-type and n-type semiconductors, is used. It is preferable that a semiconductor laser that is intentionally made such that a relaxation oscillation easily occurs be used.

In the first embodiment, the emission intensity of the first wave is made to be about twice to third times the plateau value by using to the relaxation oscillation. However, the invention is not limited thereto, any semiconductor laser in which the emission intensity of the first wave becomes equal to or larger than 1.5 times the plateau value can be used.

In the first and second embodiments, in order to form one recording mark RM, the intensity of the second and the subsequent pulse laser output beams LMp are reduced from that of the first pulse laser output beams LMp. However, the invention is not limited thereto. For example, the intensity of the first, second, or subsequent pulse laser output beams LMp may be set at the same level. Moreover, the intensity of the pulse laser output beam LMp can be switched among three or more values. In this case, the oscillation current value α may be switched among three or more values, or the current wave supply time β may be switched among three or more values.

Moreover, the structures of the first and second embodiments may be combined. For example, the setting of the oscillation current value α and the setting of the current wave supply time β may be combined as appropriate. In this case, for example, using a table stored in the laser controller 20, the laser controller 20 sets the oscillation current value α and the current wave supply time β in accordance with a length of a recording mark RM.

In the first and second embodiments, recording marks RM have lengths in the range of 2T to 11T. However, the invention is not limited thereto, and the length of the recording mark RM is not limited. For example, information can be recorded in accordance with the presence and absence of a recording mark RM having a length of 1T to which “1” or “0” is allocated. Instead of forming one recording mark RM (i.e., 1T) with one pulse laser output beam LMp, a recording marks RM may be formed with two ore more pulse laser output beams LMp.

In the first embodiment, the current wave supply start time TS is changed in accordance with increase/decrease in the oscillation current value α. However, the invention is not limited thereto, and the current wave supply start time TS may be unchanged when the oscillation current value α increases/decreases.

In the first embodiment, the second oscillation current value α2 is aligned to the reference clock CK and the current wave supply start time TS is delayed from the reference clock CK for the first oscillation current value α1. However, the invention is not limited thereto. For example, the first oscillation current value α1 may be aligned to the reference clock CK, and current wave supply start time TS may precede the reference clock CK for the second oscillation current value α2. The oscillation current values may be aligned with either of a rising edge and a declining edge of the reference clock CK.

In the first and second embodiments, the servo control is conducted using the servo layer 104. However, the invention is not limited thereto. For example, servo marks for servo control may be preformed in the recording layer 101 so that servo control can be conducted using the servo marks. In this case, the optical disc 100 may include no servo layer 104.

In the first and second embodiments, the recording mark RM is constituted by a pit. However, the invention is not limited thereto. For example, a recording mark RM may be formed by locally changing an index of refraction by a chemical reaction

In the first and second embodiments, the laser controller 20 is disposed outside the optical pickup 17. However, the invention is not limited thereto, and the laser controller 20 may be disposed inside the optical pickup 17.

In the first and second embodiments, the optical disc 100 is irradiated with the information light beam LM from the substrate 102 side. However, the invention is not limited thereto. The optical disc 100 may be irradiated with the information light beam LM from one or two sides of the optical disc 100 including the substrate 103 side. A method of irradiating a disc with an information light beam LM from both sides of the disc is disclosed, for example, in Japanese Unexamined Patent Application Publication No. 2008-71433.

In the first and second embodiments, the information light beams LM having the same wavelength is used for recording and reproducing information. However, the invention is not limited thereto. An information light beam LM used for reproducing information may have a wavelength shorter than that of an information light beam LM used for recording information.

In the first and second embodiments, the optical disc 100 having a disc shape is irradiated with the information light beam LM while the optical disc is rotating. However, the present invention is not limited thereto. An optical information recording medium may be formed, for example, in a rectangular shape, and information may be recorded on the information recording medium by moving an objective lens at a constant speed.

In the first and the second embodiments, the wavelength of the information light beam LM emitted by the semiconductor laser 51 may be different from 405 [nm]. Any wavelength that allows a recording mark RM to be formed in the vicinity of the target position PG of the recording layer 101 can be used.

In the first and second embodiments, the optical disc devices 10 and 110 are optical information recording/reproducing devices that can record information on and reproduce information from the optical disc 100. However, the invention is not limited thereto. The optical disc device may be an optical information recording device that can only record information on the optical disc 100.

In the first embodiment, the optical disc device 10 serving as an information recording device includes the semiconductor laser 51 serving as a semiconductor laser, the objective lens 18 serving as a light irradiation section, and the laser controller 20 serving as a laser controller. However, the invention is not limited thereto. An optical information recording device according to an embodiment of the invention may include a semiconductor laser, a light irradiation section, and a laser controller having various structures.

The present application contains subject matter related to that disclosed in Japanese Priority Patent Application JP 2008-197029 filed in the Japan Patent Office on Jul. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical information recording device comprising:
a semiconductor laser for emitting laser light;
a light irradiation section for collecting the laser light and irradiating an optical information recording medium with the laser light; and
a laser controller for supplying the semiconductor laser with a laser drive current wave in pulse form, the laser drive current wave having an oscillation current value that causes a relaxation oscillation of the semiconductor laser.

2. The optical information recording device according to claim 1,
wherein the laser controller sets a current wave supply time shorter than an initial oscillation time, the current wave supply time being an interval between the times when the laser drive current wave having the oscillation current value is started to be supplied and stopped being supplied, the initial oscillation time being the sum of an oscillation period of the relaxation oscillation and an emission start time, and the emission start time being an interval between the time when the laser drive current wave is started to be supplied and the time when the laser light is started to be emitted.

3. The optical information recording device according to claim 2,
wherein the laser controller increases and decreases an emission intensity of the laser light by varying the oscillation current value.

4. The optical information recording device according to claim 3,
wherein the laser controller varies a current wave supply start time in accordance with an increase and a decrease in the oscillation current value, the current wave supply start time being a time at which the laser drive current wave is started to be supplied.

5. The optical information recording device according to claim 2,
wherein the laser controller increases and decreases the emission intensity of the laser light by varying the current wave supply time.

6. The optical information recording device according to claim 1,
wherein the light irradiation section forms a recording mark representing information by causing a refractive index modulation in a vicinity of a focal point of the laser light in accordance with irradiation of a homogeneous recording layer of the optical information recording medium with the laser light.

7. The optical information recording device according to claim 6,
wherein the laser controller forms the recording mark with the laser light in accordance with a plurality of laser drive current waves and varies the oscillation current value of the plurality of laser drive current waves so that a width of the recording mark is substantially constant.

8. The optical information recording device according to claim 6,
wherein the light irradiation section irradiates the recording layer with the laser light, the recording layer containing a material that exhibits nonlinear absorption with respect to an amount of the laser light.

9. The optical information recording device according to claim 8,
wherein the material exhibiting the nonlinear absorption is a two-photon absorption material that simultaneously absorbs two photons of the laser light.

10. The optical information recording device according to claim 9,
wherein the light irradiation section causes the refractive index modulation in the vicinity of the focal point of the laser light by forming a pit in accordance with the irradiation of the laser light.

11. The optical information recording device according to claim 1,
wherein the light irradiation section irradiates a recording layer with the laser light, a recording mark being formed in the recording layer in accordance with an accumulated amount of the laser light, and
wherein the laser controller sets a current wave supply time at an oscillation time, the current wave supply time being an interval between the times when the laser drive current wave having the oscillation current value is started to be supplied and stopped being supplied, the oscillation time being the sum of an emission start time and a multiple of an oscillation period of the relaxation oscillation, and the emission start time being an interval between the time when the laser drive current wave is started to be supplied and the time when the laser light is started to be emitted.

12. An optical pickup comprising:
a semiconductor laser for emitting laser light;
a light irradiation section for collecting the laser light and irradiating an optical information recording medium with the laser light; and
a laser controller for supplying the semiconductor laser with a laser drive current wave in pulse form, the laser drive current wave having an oscillation current value that causes a relaxation oscillation of the semiconductor laser.

13. A method for emitting laser light comprising the steps of:
supplying a semiconductor laser with a laser drive current wave in pulse form, the laser drive current wave having an oscillation current value that causes a relaxation oscillation of the semiconductor laser; and
emitting laser light generated by the relaxation oscillation.
